(19) United States
(12) Patent Application Publication
(10) Pub. No.: US 2019/0219342 A1
(43) Pub. Date: Jul. 18, 2019

(54) MOTOR VEHICLE WITH RADIATOR COVER

(71) Applicant: FORD GLOBAL TECHNOLOGIES, LLC, Dearborn, MI (US)

(72) Inventors: Christoph Kueppers, Kerpen (DE); Martin Otto Alfred Konrad, Wermelskirchen (DE)

(21) Appl. No.: 16/245,529

(22) Filed: Jan. 11, 2019

(30) Foreign Application Priority Data
Jan. 12, 2018 (DE) 102018200475.7

(51) Int. Cl. F28F 9/00; F28F 19/00; B60R 19/52

(52) U.S. Cl. CPC F28F 9/002; F28D 2021/0091; B60R 19/52; F28F 19/002

(57) ABSTRACT

A motor vehicle includes a radiator. A cover is arranged on the radiator and covers the radiator at a specific place to prevent damage to the radiator in the event of an impact or crash.

### TECHNICAL FIELD

This document relates to a motor vehicle with a cover attached to a radiator and protecting the radiator against damage.

### BACKGROUND

A heat exchanger of a motor vehicle is known from the US 20120222837 A1 and comprises a frame, several pipes running parallel between two opposing sides, a pair of distributors wherein each is arranged on one corresponding opposing side of the frame, and a protective grille. The protective grille is attached to the front of the heat exchanger and includes several parallel grille elements wherein each of these grille elements is designed to screen a corresponding pipe.

### SUMMARY

The object is to provide a cover for a radiator of a motor vehicle with which the radiator can be protected against damage.

This is achieved by a motor vehicle according to the following claims.

The motor vehicle has a radiator on which a cover is arranged which covers the radiator at a specific place.

The radiator is thus more resistant to damage which may be caused more particularly by adjacent structural elements as potential contact partners in the event of a crash.

In an advantageous design of the motor vehicle, the cover is arranged on an upper side of the radiator. The cover is more particularly then arranged centrally on the upper side of the radiator.

The part of the radiator which is most endangered in the event of a head-on crash, the upper front edge, is thus additionally protected. Through the central arrangement on the upper side of the radiator, the radiator is protected against a symmetrically formed grille shutter as a potential contact partner.

In a further advantageous design of the motor vehicle, the cover has a cover width which is less than a radiator width.

The at least one cover can thus be deliberately arranged at the places which are most in danger, without taking up essential additional structural space.

In a further advantageous design of the motor vehicle, the cover is fixed on the radiator. The cover more particularly then has spring clips as the fastening elements and is fixed on the radiator by means of these. In an alternative embodiment, the cover is fixed on the radiator by rivet connection.

It is thus possible to produce a prefitted unit comprising the radiator and cover. A manufacturing process is thus not significantly lengthened by additionally attaching the cover.

In a further advantageous design of the motor vehicle, the cover is made from a plastic.

The cover can thus be designed in one piece and manufactured in a very cost-efficient manner.

### BRIEF DESCRIPTION OF THE DRAWING FIGURES

Further advantages of the motor vehicle are apparent from the detailed description and figures. The motor vehicle will now be explained in further detail with reference to the figures and following description.

FIG. 1 shows a motor vehicle in an exemplary design;

FIG. 2 shows a cover of the motor vehicle in an exemplary design;

FIG. 3 shows a sectional view of the cover with a radiator of the motor vehicle;

FIG. 4 shows a front view of the cover with radiator;

FIG. 5 shows the motor vehicle after a head-on crash; and

FIG. 6 shows an alternative embodiment wherein the cover is connected to the radiator by means of a rivet connection.

### DETAILED DESCRIPTION

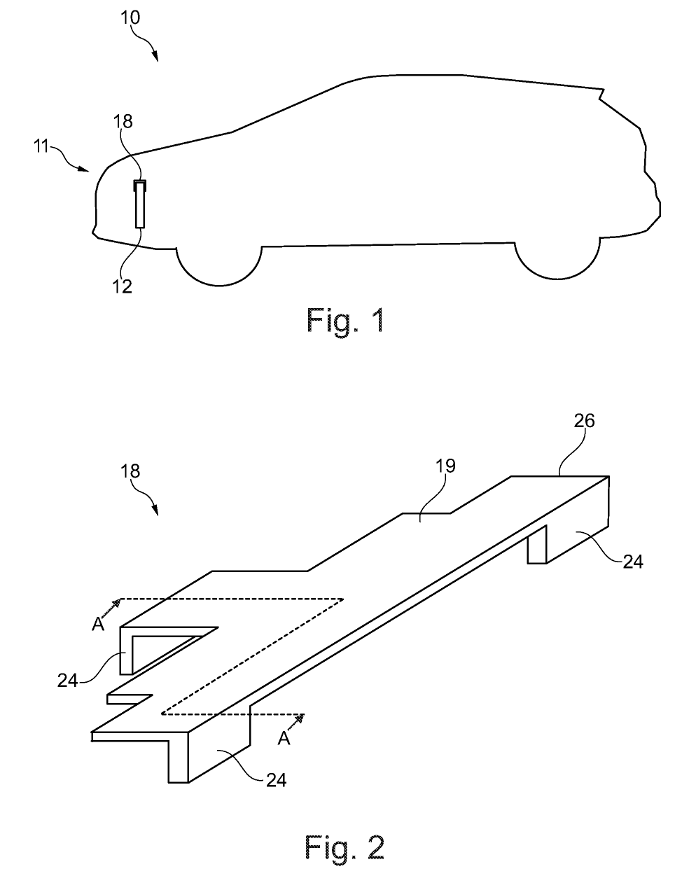

FIG. 1 shows diagrammatically the new and improved motor vehicle 10 in an exemplary design. The motor vehicle 10 comprises a radiator 12 which as normal is permeated by a cooling agent in order to create a heat exchange between the coolant and the surroundings of the radiator 12. The radiator 12 is by way of example an engine radiator, oil cooler or an intercooler. The radiator 12 is preferably positioned toward the front 11, in a front region of the motor vehicle 10, in order to be able to direct the airstream easily to the radiator 12.

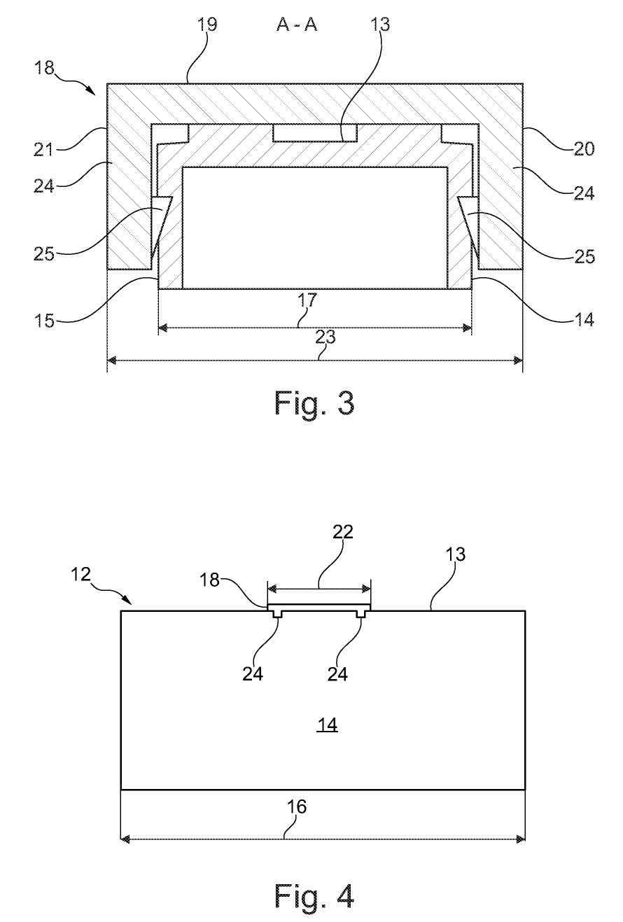

At least one cover 18 is provided on the radiator 12. The cover 18 covers the radiator 12 in areas and thus protects the radiator against damage. The cover 18 is shown in more detail in FIGS. 2 to 4 in different designs.

The radiator 12 has essentially the form of a cuboid with a narrow radiator depth 17 compared to a radiator width 16. The radiator 12 has a radiator front side 14 and a radiator rear side 15 wherein the radiator front side 14 is arranged facing towards the front 11. An upper side 13 of the radiator is arranged facing a front hood, more particularly an engine hood of the motor vehicle 10.

As best illustrated in FIG. 2, the cover 18 is formed more particularly from a cover plate 26. The cover plate 26 forms an upper side 19 of the cover. At least one arm 24 is preferably arranged on the cover plate 26 and protrudes at an angle from the cover plate 26 at the edge of the cover plate 26. The cover 18 more particularly has at least one arm 24 on a front side 20 of the cover and at least one arm 24 on the rear side 21 of the cover. It is shown in this way in FIGS. 1 to 5. The cover 18 has a specific cover width 22 and a specific cover depth 23.

The cover 18 is arranged with the cover plate 26 lengthwise along one side of the radiator 12 which extends along the radiator depth 17 and the radiator width 16. The cover plate 26 then more particularly rests on the radiator 12. The cover 18 is more particularly arranged with the cover plate 26 on the radiator upper side 13, more particularly in the center. An off-center arrangement is also possible. The cover 18 is preferably arranged on the radiator 12 in such a way that the cover plate 26 projects beyond the radiator depth 17. The arms 24 then project down on the front side 14 of the radiator and/or rear side 15 of the radiator. The arms 24 serve to position the cover 18 and more particularly to fasten the cover 18. The cover 18 is thus preferably fixed on the radiator 12. At least one arm 24 can have for this a fastening element 25, more particularly a spring clip which is designed to produce a form-fitting connection with the radiator 12. As illustrated in FIG. 6, the cover 18 is alternatively riveted to the radiator 12 by rivet 27. In still other embodiments, the cover 18 may be connected to the radiator 12 by at least one screw or an adhesive.

The cover 18 is preferably dimensioned such that the cover 18 has a cover width 22 which is less than a radiator width 16. The cover width 22 is more particularly a third, more particularly half, as large as the radiator width 16.

The cover 18 is made at least in part preferably from a plastic. The spring clip is thus more particularly made from a plastic. Alternatively, or additionally at least one part of the cover 18 can be made from a metal.

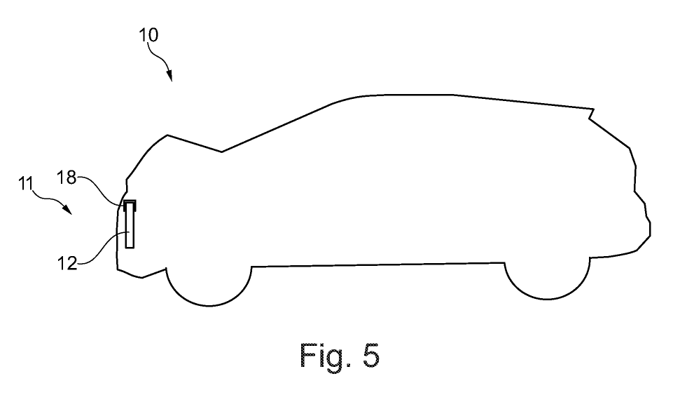

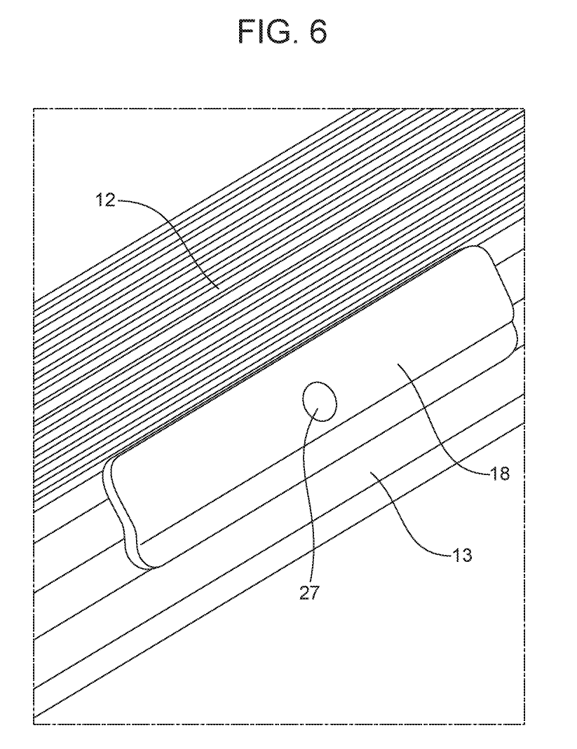

FIG. 5 shows the function of the cover 18. The front 11 of the motor vehicle 10 deformed in a head-on crash then does not touch the radiator 12, but only the cover 18. The radiator 12 itself thereby remains secured against damage.

What is claimed:

1. A motor vehicle, comprising:
a radiator; and
a cover mounted on the radiator wherein the cover covers the radiator at a specific place.

2. The motor vehicle as claimed in claim 1, wherein the cover is arranged on an upper side of the radiator.

3. The motor vehicle as claimed in claim 2, wherein the cover is arranged on the upper side of the radiator.

4. The motor vehicle as claimed in claim 3, wherein the cover has a cover width which is less than a radiator width.

5. The motor vehicle as claimed in claim 4, wherein the cover is fixed on the radiator.

6. The motor vehicle as claimed in claim 5, wherein the cover has spring clips that engage the radiator and fix the cover on the radiator.

7. The motor vehicle as claimed in claim 5, wherein the cover is fixed on the radiator by rivet connection.

8. The motor vehicle as claimed in claim 1, wherein the cover is made from a plastic.

9. The motor vehicle as claimed in claim 1, wherein the cover is fixed on the radiator.

10. The motor vehicle as claimed in claim 1, wherein the cover has spring clips that engage the radiator and fix the cover on the radiator.

11. The motor vehicle as claimed in claim 1, wherein the cover is fixed on the radiator by rivet connection.
